(19) United States
(12) Patent Application Publication
(10) Pub. No.: US 2013/0182540 A1
(43) Pub. Date: Jul. 18, 2013

(54) POSITION SENSOR

(71) Applicants: Michael Robert Lyons, Solihull (GB); Nathanael Peter Rice, Birmingham (GB)

(72) Inventors: Michael Robert Lyons, Solihull (GB); Nathanael Peter Rice, Birmingham (GB)

(73) Assignee: ROLLS-ROYCE ENGINE CONTROL SYSTEMS LTD, Derby (GB)

(21) Appl. No.: 13/824,787

(22) PCT Filed: Sep. 15, 2011
(86) PCT No.: PCT/GB2011/001347

§ 371 Date: Mar. 18, 2013

(30) Foreign Application Priority Data
Sep. 21, 2010 (GB) 1015745.1

(51) Int. Cl. F15B 15/28

(52) U.S. Cl. CPC F15B 15/2884
USPC 367/99

(57) ABSTRACT

A position sensor system for use in sensing the position of a component located within a housing and disposed, at least in part, within a fluid, the system comprising a first acoustic position sensor operable to transmit a first acoustic signal through the fluid and to sense a reflection of the first acoustic signal from a first surface to derive a first position signal, a second acoustic position sensor operable to transmit a second acoustic signal through the fluid and to sense a reflection of the second acoustic signal from a second surface to derive a second position signal, and means operable, using the first and second position signals, to derive a position signal indicative of the position of the component within the housing.

This invention relates to a system for use in sensing the position of a moveable component. In particular it relates to sensing the position of a component, at least part of which is located within a fluid. One area in which the invention may be used is in aerospace applications, such as in fuel control systems. It will be appreciated, however, that the invention may also be used in a number of other applications.

There are a number of circumstances in which it is desirable to monitor the positions of movable components, and in particular components which are located, at least in part, within a fluid. For example, where a valve or actuator is provided in a device or piece of equipment, it may be desirable to be able to monitor the position or status of the valve or actuator.

One application in which it is desirable to be able to monitor, accurately, the position of a movable component is in the fuel metering unit associated with an aircraft engine. Such a unit will typically include a metering valve having a valve member that is moveable to control the rate at which fuel is able to flow through the metering valve, and thereby to control the rate at which fuel is delivered to the engine. One form of metering valve used in such applications includes a valve member that is reciprocable within a bore formed in a valve housing. The ends of the valve member define, with the adjacent parts of the bore, control chambers. By controlling the fluid, typically fuel, pressures applied to the control chambers, the valve member can be moved to desired positions. It is usual to provide the metering valve with a position sensor operable to monitor the position of the valve member and output a signal indicative of the position of the valve member to an associated controller to allow the controller to control the operation of the metering valve in a closed loop fashion.

The position sensors often used in such applications typically take the form of fine wire inductive sensors such as LVDTs and RVDTs. Such sensors are usually of relatively high cost, weight and size, and so are difficult to accommodate. Furthermore, component reliability can be a problem.

Another form of position sensor that has been used in this type of application is an acoustic or ultrasonic position sensor. Such a sensor includes an acoustic wave transmitter operable to transmit a sound wave, typically at ultrasonic frequencies, and sensor means operable to detect a reflected sound wave arising from the transmitted signal being reflected from a surface. By monitoring the time that elapses between the transmission of the sound wave and the reception of the reflected sound wave the distance between the sensor and the surface from which the sound wave was reflected can be calculated.

U.S. Pat. No. 5,228,342 describes the use of an acoustic sensor in monitoring the position of a check valve. The sensor operates in substantially the manner outlined hereinbefore.

U.S. Pat. No. 4,926,693 describes the use of an ultrasonic sensor in monitoring the position of a piston. In this arrangement, the ultrasonic sensor takes the form of a piezoelectric crystal mounted upon a Pyrex plate arranged parallel to an end face of the piston. The crystal is driven at its resonant frequency. Variations in the position of the piston result in the crystal impedance changing and so by monitoring the crystal impedance, an output signal indicative of the piston position can be obtained.

Whilst the use of sensors of this type in the application outlined hereinbefore may overcome some of the disadvantages mentioned hereinbefore, they do have the disadvantage that the sound waves would have to be transmitted through the fluid within one of the control chambers, and variations in certain parameters of the fluid would give rise to errors in the sensed position information. For example, variations in the fuel, fuel quality, density, bulk modulus or significant changes in fuel pressure or temperature can give rise to changes in the speed at which sound waves travel through the fluid. As variations in the speed at which sound waves are transmitted through the fluid will change the length of the interval between transmission of the sound wave and reception of the reflected sound wave for a given position, it will be appreciated that accurate position sensing would not be possible unless these fuel parameters are accounted for in the calculation of position carried out by the controller, which would require the use of a number of separate sensors (ie fuel temperature and pressure sensors). Consequently, the position sensing arrangement would need to be of relatively complex form.

It is an object of the invention to provide a position sensor system suitable for use in such applications and which is of relatively simple and convenient form.

According to the present invention there is provided a position sensor system for use in sensing the position of a component located within a housing and disposed, at least in part, within a fluid, the system comprising a first acoustic position sensor operable to transmit a first acoustic signal through the fluid and to sense a reflection of the first acoustic signal from a first surface to derive a first position signal, a second acoustic position sensor operable to transmit a second acoustic signal through the fluid and to sense a reflection of the second acoustic signal from a second surface to derive a second position signal, and means operable, using the first and second position signals, to derive a position signal indicative of the position of the component within the housing.

By using two acoustic position sensors which both transmit signals through the fluid, the effect of variations in the speed at which sound is transmitted through the fluid can be cancelled out or compensated for with the result that the position signal derived in accordance with the invention is of enhanced accuracy.

Conveniently the component is slidable within the housing and the first and second surfaces are defined by opposing surfaces of the component. Conveniently, the first and second surfaces define, with the housing, respective first and second control chambers to which fluid at controlled pressures can be applied to control the position of the component within the housing. For example, the component may comprise a valve member, for example a metering valve member. Alternatively, it may comprise, for example, a piston or hydraulic ram or actuator.

In such an arrangement the position signal may be derived using the ratiometric formula:

$$Component position = \frac{t 1 - t 2}{t 1 + t 2}$$

where
t1 is the first position signal; and
t2 is the second position signal.

The first and position signals conveniently take the form of time measurements indicative of the time interval between the transmission of the first and second acoustic signals and the reception of the respective reflections thereof.

In another arrangement, the second acoustic position sensor may be arranged to output a signal indicative of the time interval between the transmission of the second acoustic signal and the reception of the reflection thereof from a fixed second surface so as to provide a calibration signal to be used in conjunction with the output of the first acoustic position sensor to determine the position signal.

Conveniently the first and second acoustic position sensors each include a piezoelectric-based acoustic source.

To provide the required level of redundancy for use in aerospace applications, a pair of first acoustic position sensors and a pair of second acoustic position sensors may be provided.

As the transmitted signals may be reflected from other surfaces in addition to being reflected from the first and second surfaces, the means operable to derive the position signal is preferably arranged to distinguish the reflections from the first and second surfaces from other spurious reflections. For example, where the acoustic position sensors are located externally of, for example, at least part of the housing, some spurious reflections may occur at the interface between the inner surface of the housing and the fluid. However, as the time at which these reflections can be expected to be received is known, distinguishing them from the reflections from the first and second surfaces is relatively straightforward.

The invention will further be described, by way of example, with reference to the accompanying drawings, in which:

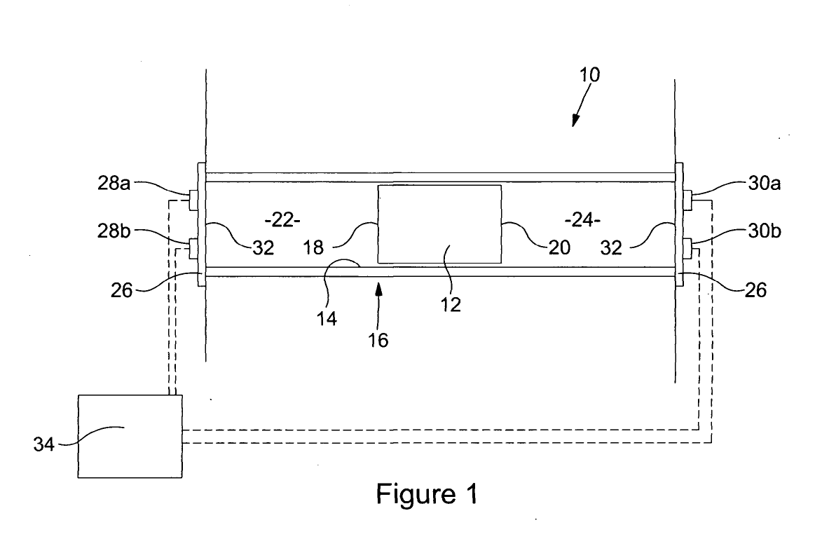

FIG. 1 is a diagram illustrating a position sensor system in accordance with one embodiment of the invention;

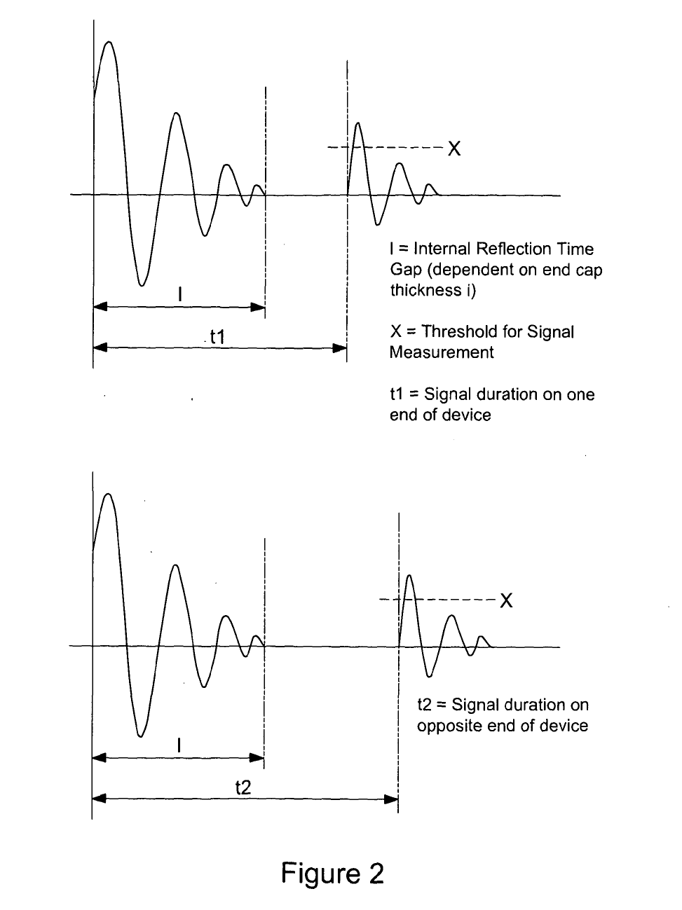

FIG. 2 illustrates example output signals from the acoustic position sensors thereof; and

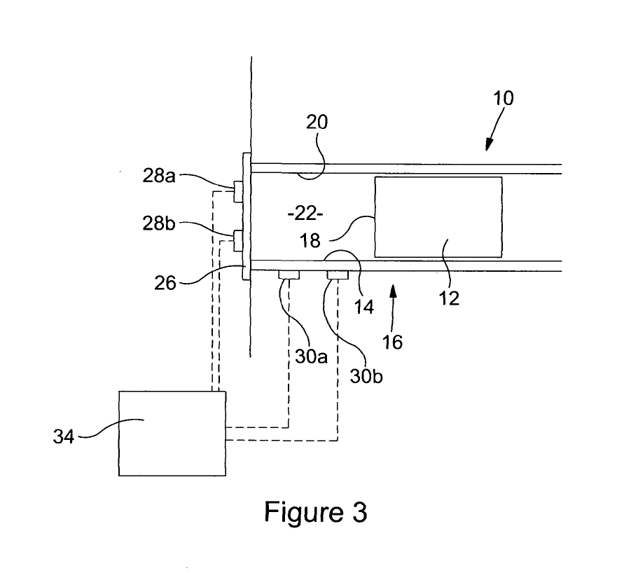

FIG. 3 is a view similar to FIG. 1 illustrating an alternative embodiment.

Referring firstly to FIG. 1 there is illustrated a valve assembly 10 comprising a valve member 12 slidable within a bore 14 formed in a housing 16. The ends of the bore 14 are closed by end caps 26. The valve could comprise, for example, a metering valve for use in a fuel metering unit associated with an aircraft engine. However, the invention may be used in a number of other applications including other forms of valve, or in monitoring the positions of pistons, hydraulic rams and the like.

The valve member 12 defines first and second end surfaces 18, 20. The first surface 18 and adjacent part of the bore 14 together form a first control chamber 22, and the second surface 20 and adjacent part of the bore 14 together form a second control chamber 24. It will be appreciated that by controlling the relative fluid pressures applied to the control chambers 22, 24, the valve member 12 can be moved to, and held in, a desired position within the bore 14. The manner in which such control can be achieved is well known and will not be described in further detail herein.

The outer face of the end cap 26 closing the first control chamber 22 is provided with a pair of first piezoelectric acoustic position sensors 28a, 28b, and the outer face of the end cap 26 closing the other control chamber 24 is provided with a pair of second piezoelectric acoustic position sensors 30a, 30b. The sensors may be of substantially conventional form, for example including a piezoelectric ceramic material transducer operable to transmit an acoustic signal of frequency in the range of 2 to 10 MHz, and sense the reception of a reflection thereof. Each of the position sensors 28a, 28b, 30a, 30b is arranged, in use, to generate and transmit an acoustic wave through the associated end cap 26 and the fluid within the adjacent control chamber 22, 24, the acoustic wave being incident upon and reflected by the associated end surface 18, 20 from where it passes back through the associated control chamber 22, 24 and end cap 26 to be detected by the respective position sensor. To avoid interference between the operation of the sensors 28a, 28b, they are conveniently arranged to output acoustic waves of different frequencies to one another, or to operate at different times to one another. Likewise, the sensors 30a, 30b conveniently operate at different frequencies or at different times to one another. It will be appreciated that the time interval between the transmission of the acoustic wave by one of the sensors 28a, 28b, 30a, 30b and reception of the reflected wave by that sensor is related to the distance of the associated end surface 18, 20 from that sensor. Each sensor, or control means associated therewith, is operable to output a signal indicative of the time interval between the transmission of such an acoustic signal and the reception of a reflection thereof, and hence of the position of the surface from which the signal is reflected. As noted hereinbefore, other factors such as the speed of sound transmission through, for example, the fluid within the associated control chamber 22, 24 also impact upon the length of this time interval, thus the output signals mentioned hereinbefore cannot be relied upon, alone, to provide an accurate indication of the location of the valve member 12 within the housing 16.

In this embodiment of the invention, in order to arrive at an accurate indication of the location of the valve member 12 within the housing 16, the time intervals sensed by the sensors 28a, 30a are processed in conjunction with one another to permit compensation for any variations in the speed of transmission of sound through the fluid. Likewise, the outputs of the sensors 28b, 30b are processed in conjunction with one another. By providing two first sensors 28 and two second sensors 30, it will be appreciated that the position sensor system provides redundancy to allow continued accurate position sensing in the event of a failure of, for example, one of the sensors. Where used with a dual channel control unit, the outputs from the sensors 28a, 30a may be supplied to one of the channels, and the outputs of the other sensors 28b, 30b supplied to the other of the channels thereof.

One technique by which compensation for variations in the speed of transmission of sound through the fluid can be made is to calculate, for each channel, the position of the valve member 12 within the housing 16 using the following ratiometric equation:

$$value member position = \frac{t 1 - t 2}{t 1 + t 2}$$

where
t1 is the time interval sensed by the associated first sensor 28; and
t2 is the time interval sensed by the associated second sensor 30.

A valve member position value so calculated is a dimensionless value indicative of the position of the valve member 12 within the housing 16. In such an arrangement, if the sensed time intervals t1, t2 are equal, the calculated valve member position value will be 0, indicating that the valve member 12 occupies a central position within the housing 16, ie the distance of the first surface 18 from the first sensor 28 is equal to the distance of the second surface 20 from the second sensor 30. If the time interval t1 is three times the value of t2, the calculated position value will be ½, indicating that the valve member 12 occupies a position ¾ of the way along the housing 16, closest to the end at which the sensors 30a, 30b are located. A calculated value of −⅓ as would occur if the time interval t1 were half that of t2 indicates that the valve member 12 is ⅓ of the way along the housing 16, closest to the end at which the sensors 28a, 28b are located.

It will be appreciated that as the same fluid is contained within both of the control chambers 22, 24, the speed of transmission of sound through the fluid will be the same in both of the chambers 22, 24, thus the impact of variations in the speed of transmission of sound through the fluid is cancelled out by processing the measurements in combination as outlined hereinbefore.

In accordance with the invention, therefore, the time/position output signals from the position sensors 28, 30 are supplied to control means 34 which calculates or derives the valve position value using the relationship set out above and thereby outputs a signal representative of the position of the valve member 12 within the housing 16. If desired, the control means 34 could be incorporated into the controller of the associated engine. However, this need not always be the case and the control means could be incorporated by means of known high temperature electronics into the housing 16 or end caps 26 of the valve assembly 10. Furthermore, the control means 34 may additionally serve to monitor the outputs of the position sensors 28, 30 and measure the time intervals between the transmission of the acoustic signals and the reception of the reflections thereof.

It will be understood that, although the reflected signal of interest is the reflection that takes place at the first and second surfaces 18, 20, some internal reflection will also occur at the interfaces 32 between the end caps 26 and the fluid within the control chambers 22, 24. FIG. 2 (not to scale) is illustrative of the signals which may be received by the sensors 28, 30 from which the reflections at the interfaces 32 between the end caps 26 and fluid can clearly be seen. As the end caps 26 are of known, fixed thickness I, the sensed reflections from these interfaces can easily be identified and ignored by the control means 34 when calculating the position of the valve member 12 within the housing 16, for example by monitoring for the reception of a signal of magnitude X or more received after a time period representative of the thickness I.

In a modification to the arrangement described hereinbefore, as illustrated in FIG. 3, the second sensor 30 may be positioned so as to transmit an acoustic wave through the fluid to a second, fixed surface 20, rather than to a movable surface as in the arrangement shown in FIG. 1. As illustrated, this may be achieved by transmission of the wave across the chamber 22. However, it will be appreciated that this is just one of many possibilities. In such an arrangement, the time interval output by the second sensor 30 which is indicative of the length of time it takes for the sound wave to travel over a fixed distance through the fluid can be used in combination with the output of the first sensor to compensate for variations in the speed of transmission of sound waves through the fluid and so derive an accurate value for the distance between the sensor 28 and the surface 18 (and hence the position of the valve member 12 within the housing 16) in which compensation has been made for any variations in the speed of transmission of the acoustic wave through the fluid.

A further possibility would be to provide an arrangement similar to that described with reference to FIG. 1, supplemented by a third position sensor operable to monitor a fixed distance to provide a calibration signal that can be used, in conjunction with the outputs from the first and/or second position sensors, to validate that the system is operating correctly.

It will be appreciated that a wide range of modifications and alterations may be made to the arrangements described hereinbefore without departing from the scope of the invention. Furthermore, whilst the description hereinbefore is directed to the use of the invention in an aerospace, fuel system related application, it will be appreciated that the invention may also be used in a wide range of other applications, both in aerospace technologies and in other technologies.

1. A position sensor system for use in sensing the position of a component located within a housing and disposed, at least in part, within a fluid, the system comprising a first acoustic position sensor operable to transmit a first acoustic signal through the fluid and to sense a reflection of the first acoustic signal from a first surface to derive a first position signal, a second acoustic position sensor operable to transmit a second acoustic signal through the fluid and to sense a reflection of the second acoustic signal from a second surface to derive a second position signal, and means operable, using the first and second position signals, to derive a position signal indicative of the position of the component within the housing:
wherein the component is slidable within the housing and the first surface is defined by a surface of the component; and
wherein the second acoustic position sensor is arranged to output a signal indicative of the time interval between the transmission of the second acoustic signal and the reception of the reflection thereof from a fixed second surface.

2-3. (canceled)

4. A system according to claim 1, wherein the first and second surfaces define, with the housing, control chamber to which fluid at controlled pressures can be applied to control the position of the component within the housing.

5. A system according to claim 1, wherein the component comprises one of a valve member, a metering valve member, a piston and hydraulic ram or actuator.

6-7. (canceled)

8. A system according to claim 1, wherein the first and second position signals conveniently take the form of time measurements indicative of the time interval between the transmission of the first and second acoustic signals and the reception of the respective reflections thereof.

9. A system according to claim 1, wherein the first and second acoustic position sensors each include a piezoelectric-based acoustic source.

10. A system according to claim 1, wherein the means operable to derive the position signal is further arranged to distinguish the reflections from the first and second surfaces from other spurious reflections.
